(19) United States
(12) Patent Application Publication
(10) Pub. No.: US 2007/0194474 A1
(43) Pub. Date: Aug. 23, 2007

(54) Injection molding press

(76) Inventors: Peter Samuel Nagy, Astoria, NY (US); Nelson Rivas, East Meadow, NY (US)

Correspondence Address: PETER S. NAGY;VALPLAST INTERNATIONAL CORP., 34-30 31ST STREET, LONG ISLAND CITY, NY, 11106, US

(21) Appl. No.: 11/361,416

(22) Filed: Feb. 23, 2006

(51) Int. Cl. B29C 45/76; B29C 45/02

(52) U.S. Cl. 264/40.5; 264/328.19; 425/557; 425/559; 425/145

(57) ABSTRACT

An injection press that has a hydraulic cylinder and a press piston located inside the hydraulic cylinder that is translatable within the cylinder. The press piston divides the hydraulic cylinder into engage and retract chambers. A pump and an auxiliary pressurization device are connected to the engage chamber. A transducer measures the pressure in the engage chamber. A controller receives signals from the transducer and operates the pump. The pump delivers hydraulic fluid to the engage chamber to pressurize and inject resin into a mold cavity through the piston. The controller discontinues operation of the pump when the pressure in the engage chamber reaches a specified cut-off level. The auxiliary pressurization device maintains pressure on the fluid in the engage chamber after the controller discontinues operation of the pump to provide back pressure on the injected resin. The auxiliary pressurization device may be an accumulator that is charged by the pump. Safety devices prevent the controller from operating the pump during unsafe conditions.

### BACKGROUND

The present invention relates generally to injection presses for injecting resin into a mold to form an article and for maintaining pressure on the resin inside the mold for a predetermined period of time. The present invention can be used to mold, for example, a partial or complete denture.

When a molding machine injects heated liquid resin inside a mold, the resin shrinks as it cools. Therefore, for an article that must be molded pursuant to tight tolerances, a molding machine needs to apply back pressure to force additional resin into the mold as the resin already inside the mold shrinks as it cools. The amount of shrinkage depends on the internal properties of the resin. For Valplast® brand resin, a thermoplastic nylon resin that is ideal for flexible partial dentures, a back pressure preferably is maintained for up to three minutes. In addition to compensating for shrinkage of the resin, the back pressure influences crystalline formation of the polymer as the polymer solidifies.

Injection presses are known in the art. One type of press is a manual injection press. In a manual injection press, a piston for pressurizing and injecting resin into a mold can be advanced by, for example, a hand-turned wheel. Back pressure can be maintained on the resin by, for example, compression coil springs. Manual presses require rapid and somewhat aggressive physical force to operate. This force can sometimes be greater than the operator's physical abilities, limiting the usefulness of the press.

International Application Publication WO 95/27447 discloses an injection press. In this press, an electric motor 14 rotates a screw jack 24. The screw jack 24 raises a piston that has a resin-filled cartridge on its top. The piston presses the cartridge against a compression plate. As a result, resin is injected into the mold cavity. This press is capable of maintaining back pressure on the resin. To maintain such back pressure, however, the motor must be continuously powered to torque the screw jack 24. When the time period for applying back pressure is significant, for example three minutes, the power consumption and noise resulting from continuous powering of the motor is unacceptable. Additionally, the screw-jack mechanism for translating the piston does not enable fast and smooth movement of the injection piston.

Pneumatically-actuated injection presses are also known in the art. A pneumatically-actuated press uses air pressure to advance the piston towards the resin to pressurize and then inject the resin. A disadvantage of such a press as presently exists is that it requires a high-pressure compressor and air lines that present significant installation issues and raise safety concerns. These requirements also may restrict the portability of the press.

FIG. 8 in U.S. Pat. No. 5,302,104 shows a hydraulically-actuated injection press. A hydraulic cylinder 59 translates a piston rod 61 causing a piston 60 on the end of piston rod 61 to pressurize resin R contained in a cylinder 56. The pressurized resin R is injected into a mold S contained in a flask F by way of a resin filling hole 62. For this press to maintain back pressure on the pressurized resin R, the pump that powers the hydraulic cylinder must continue operating. When back pressure must be applied for a significant time period such as three minutes, the noise and power consumption resulting from continuous operation of the pump are unacceptable. FIGS. 1-7 in the '104 patent show an injection press that can apply back pressure without continuous operation of the pump. In this press, the flask F is placed on top of a table 2 that can be translated vertically using a hydraulic cylinder. The table is moved upwards until a resin-filled cylinder on top of the flask contacts a piston 9 on a suspended piston rod 10. A compression spring contacts the opposite end of the piston rod. As the table continues its upward movement, the spring compresses, thereby pressurizing the resin R. At a predetermined pressure, a plate 14 at the bottom of the resin-filled cylinder fails, causing the spring to quickly and forcefully eject resin into the flask. Even when the mold is filled, the spring remains partially compressed. As a result, the spring can apply back pressure on the resin without continuous operation of the pump. The spring, however, significantly increases the length of the press. Additionally, the use of powerful coil springs raises safety concerns.

Another deficiency of known injection presses is that they do not actively monitor the pressure in the system and control the injection cycle based on the monitored pressure. Therefore, they mold inefficiently, wasting valuable energy and time.

Yet another deficiency of known injection presses is that they do not provide for satisfactory automated injection molding of methyl-methacrylate resin, which is also known as acrylic resin. Molding with acrylic resin does not involve rapid injection of resin into the mold. The acrylic resin, which has a dough-like consistency, is slowly advanced into the mold. The pressing force on the resin is alternated between a first force and a second force that is slightly lower than a first force. On a manual molding machine, this is accomplished by turning a screw to advance a pushing plunger to provide the first force and then by stopping the plunger and letting compression springs provide the second force. After a predetermined amount of time the plunger is advanced again. This functionality has not yet been efficiently and effectively automated.

There is a need in the art for a compact hydraulically-actuated injection press capable of exerting back pressure on the injected resin for a significant period of time without continuously operating the pump of the hydraulic system. Additionally, there is a need in the art for an injection press that actively monitors the pressure in the system and controls the injection process based on the pressure. Additionally, there is a need in the art for an injection press capable of automatically molding articles using acrylic resin effectively and efficiently.

### SUMMARY OF THE INVENTION

The present invention is directed to an injection press for delivering resin into a mold cavity comprising a hydraulic cylinder, a press piston located inside the hydraulic cylinder and translatable within the cylinder. The press piston divides the hydraulic cylinder into engage and retract chambers. A pump and an auxiliary pressurization device are connected to the engage chamber. The pump delivers hydraulic fluid to the engage chamber to translate the piston in a first direction. A controller discontinues operation of the pump when the pressure in the engage chamber reaches a specified cut-off level. The auxiliary pressurization device maintains fluid pressure in the engage chamber after the controller discontinues operation of the pump whereby the piston applies back pressure to resin inside the mold cavity. The auxiliary pressurization device may be an accumulator that is charged by the pump. The accumulator may contain nitrogen gas and may be passive.

The present invention benefits from the fast and smooth movement of the piston that can be achieved with hydraulic actuation. In addition, it does not require the permanent and potentially unsafe installation that goes hand-in-hand with pneumatic actuation. The injector is a closed system that is completely portable. It only requires standard electric power to run the pump. Additionally its length is not significantly increased or its safety compromised by large compression coil springs. Because the auxiliary pressure device provides back pressure on the resin indirectly though the hydraulic fluid and the piston, it does not become soiled with hardened resin, the removal of which would require frequent maintenance.

The pressure in the system may be monitored by a transducer. The controller may discontinue operation of the pump when the pressure measured by the transducer reaches a specified level. The controller may be reprogrammable so that a different cut-off pressure level can be specified.

The present invention is also directed to a method for injecting an acrylic resin into a mold cavity in a flask using an injection press. The injection press includes a hydraulic cylinder, a press piston located in the cylinder that divides the cylinder into engage and retract chambers, a hydraulic pump connected to the engage chamber, and an accumulator connected to the engage chamber. The first step in the method is turning on the pump to pump fluid into the engage chamber to move the piston into contact with the resin to be injected and to simultaneously charge the accumulator. The next step is turning off the pump when the pressure in the engage chamber rises to a first specified level so that the accumulator becomes the primary source of pressure in the engage chamber. The third step is turning the pump back on when the pressure in the engage chamber falls to a second specified level. The fourth step is repeating steps second and third steps until the mold cavity is completely filled with resin.

These and other features, aspects, and advantages of the present invention will become better understood with regard to the following description, appended claims, and accompanying drawings where:

### BRIEF DESCRIPTION OF THE DRAWINGS

FIG. 1 is an angle view of an injection press that is an embodiment of the invention.

FIG. 2 is an angle view of the interior of the housing of the injection press shown in FIG. 1.

FIG. 3 is an angle view of the injection cradle assembly of the injection press shown in FIG. 1.

FIG. 4 is an exploded view of the injection cradle assembly shown in FIG. 3.

FIG. 5 is a schematic of the fluid and electrical circuits for the hydraulic actuating system of the injection press shown in FIG. 1.

### DETAILED DESCRIPTION OF THE DRAWINGS AND THE INVENTION

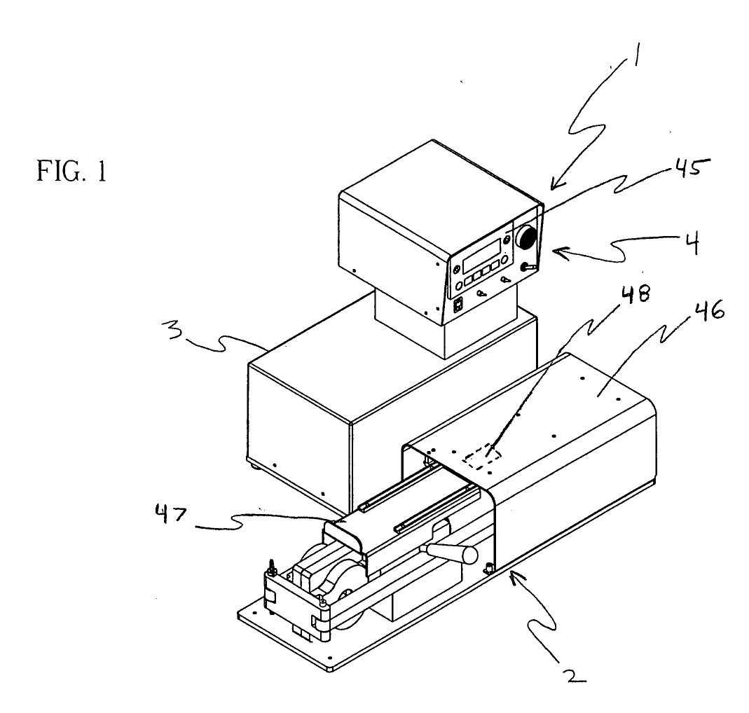

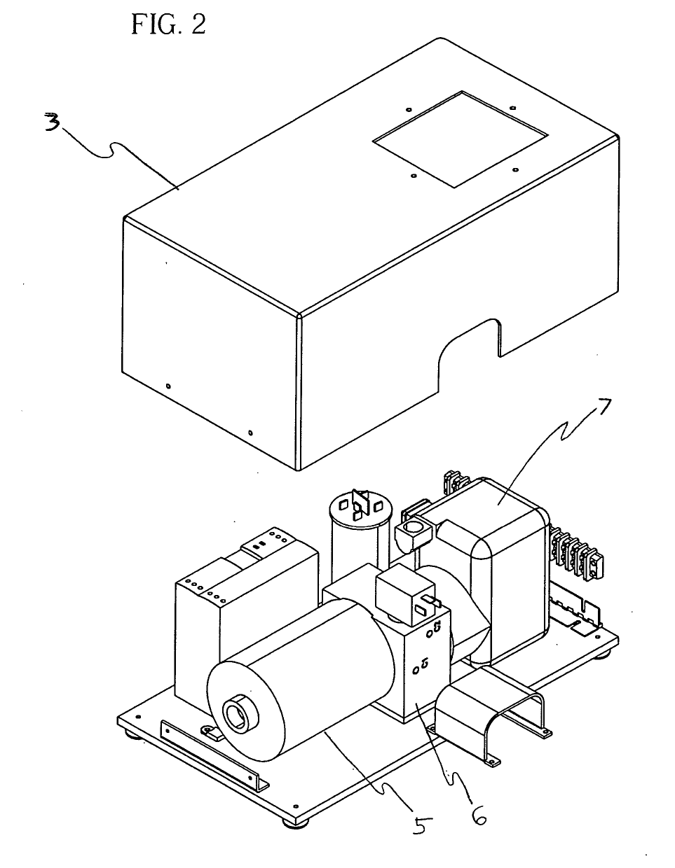

FIG. 1 shows an exemplary embodiment of an injection molding press that falls within the scope of the invention as described and claimed herein. The press 1 includes an injection cradle assembly 2, a housing 3, and a control unit 4. The housing 3 is a box-shaped compartment that contains an electric pump motor 5, a hydraulic pump 6, and a fluid reservoir 7, all of which can be seen in FIG. 2.

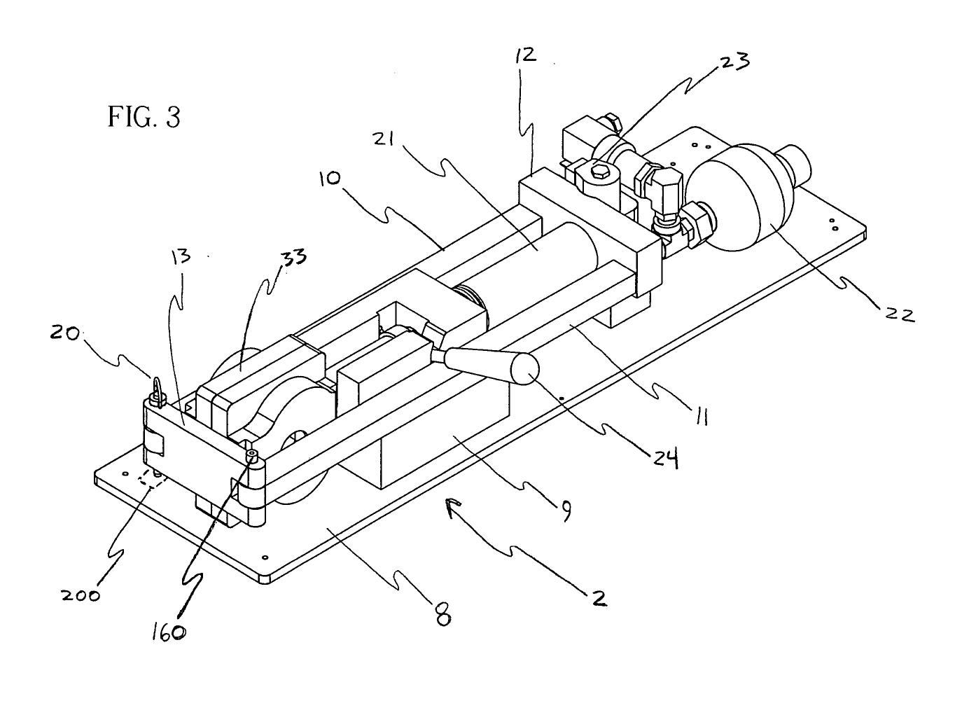

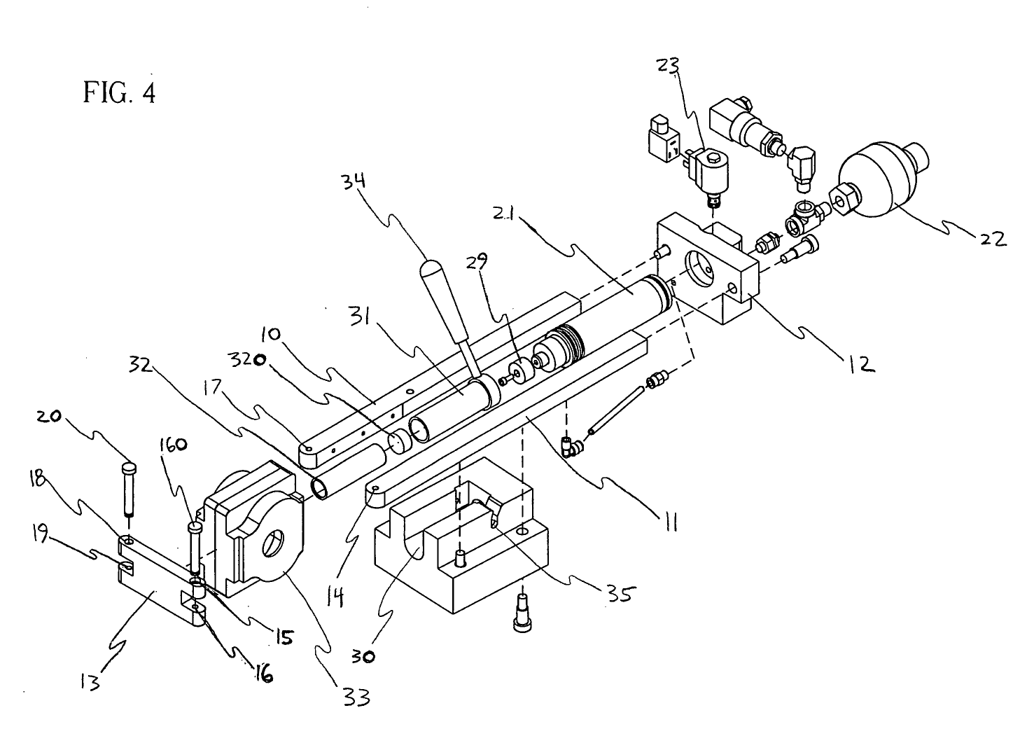

Referring to FIGS. 3 and 4, the injection cradle assembly 2 includes a rectangular base 8 and a cradle support structure that includes a cradle block 9 and arms 10 and 11. The arms 10 and 11 may be connected to the cradle block 9. Alternatively, the cradle block and the arms may be of one-piece construction. The arms support a retaining block 12 on their back ends and a swing gate member 13 on their front ends. The front end of arm 11 has a hole 14 that aligns with two holes 15 and 16 formed on flanges on the swing gate member. Hole 16 is threaded. The three holes receive a bolt 160 that is screwed into the threaded hole. The combination of the bolt and holes create a hinge for the swing gate member. The front end of arm 10 has a hole 17 that aligns with holes 18 and 19 on flanges on the other side of the swing gate member. A pin 20 can be inserted through the three holes to lock the swing gate member from rotating about the axis of the hinge joint. The pin 20 closes a switch 200 (schematically shown in FIG. 3) when it is inserted through the holes to lock the swing gate member.

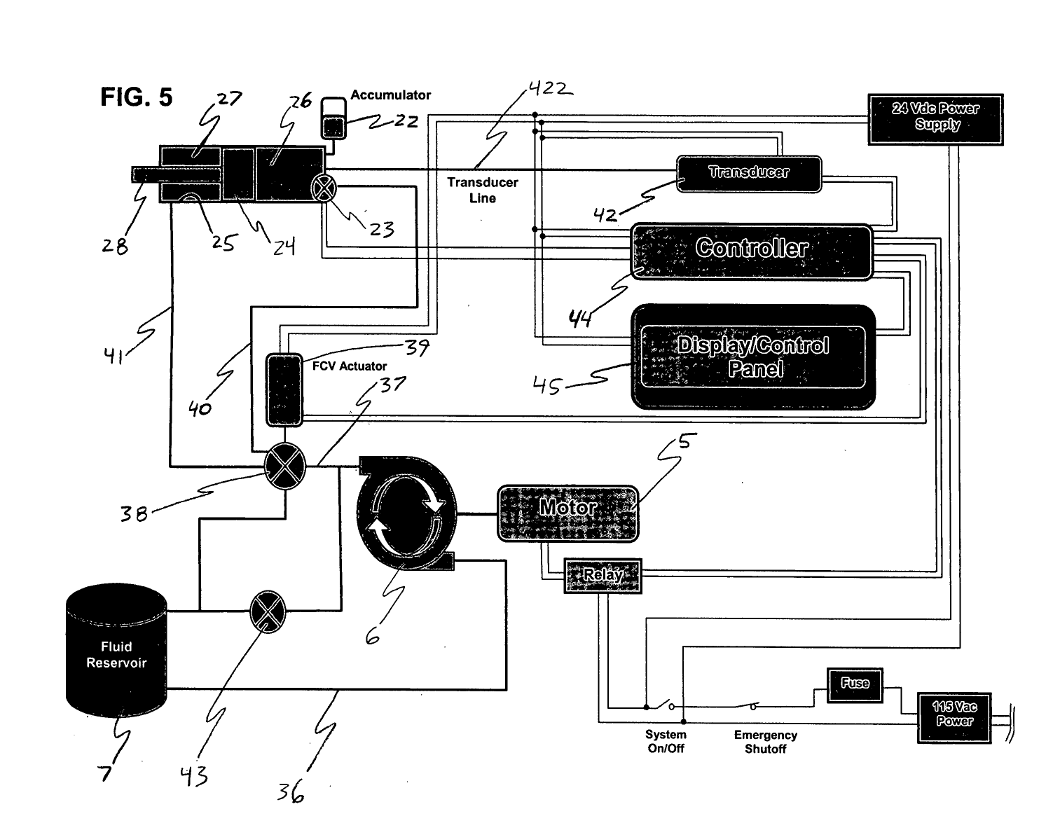

The retaining block 12 supports a plunger 21 on its front face, an accumulator 22 on its back face, and a controllable check valve 23 on one of its top faces. The accumulator is, for example, a diaphragm accumulator that has two chambers separated by a diaphragm. One of the chambers is filled with nitrogen gas. Another type of accumulator may also be used, for example, a bladder accumulator, which can also be filled with nitrogen gas. Nitrogen-filled diaphragm and bladder accumulators are passive devices; they do not require active control such as with valves and actuators to perform their function. The components of the plunger are shown schematically in FIG. 5. The plunger contains press piston 24. The interior of the plunger forms a cylinder 25 in which the press piston slides. The press piston divides the cylinder into an engage chamber 26 and a retract chamber 27. The accumulator 22 and the controllable check valve 23 are in communication with the engage chamber 26 of the cylinder. A rod 28 extends from the press piston on its retract-chamber side. The rod extends outside of the cylinder of the plunger.

Referring back to FIGS. 3 and 4, the front end of the plunger is supported by a bore (not shown) in the back face of cradle block 9. A replaceable plunger cap 29 is connected to the front side of the external piston to protect the external piston. A recess 30 in the base can support a removable hollow resin cartridge holder 31. Resin cartridge holder 31 can fit a resin cartridge 32 inside of it.

A removable two-piece metal flask 33 can fit in the space between the front face of the cradle block 9 and the swing gate member 13. The flask contains a mold (not shown) for the article being manufactured, for example a partial denture of a particular shape.

A handle 34 extends from the back end of the cartridge holder 31. The handle cooperates with a cam groove 35 in cradle block 9. After an operator inserts the cartridge holder 31 into the recess 30, he or she then turns the handle 34 so that it enters the cam groove 35. Further turning of the handle will cause the cartridge holder 31 to advance linearly until its front end contacts a cylindrical recess (not shown) on the back face of the flask. In this position, the cartridge is aligned with a sprue opening (not shown) in the flask that provides a path for resin to flow into the internal mold cavity.

Referring to FIG. 5, fluid pressure in the hydraulic actuating system is applied by hydraulic pump 6. The pump is powered by electric pump motor 5. The pump draws fluid from the fluid reservoir 7 through pump input line 36. The pump is, for example, a positive displacement pump such as a centrifugal pump. A pump output flow line 37 connects the pump to a flow control valve (“FCV”) 38. The flow control valve is controlled by FCV actuator 39, which is a solenoid. Flow control valve 38 can deliver hydraulic fluid output from the pump to either the engage chamber 26 of the cylinder through a forward flow line 40 or the retract chamber 27 through a reverse flow line 41. When the flow control valve 38 connects the pump output to either the forward or the reverse flow line, it simultaneously connects the other flow line to the fluid reservoir 7. The controllable check valve 23 is between the forward flow line 40 and the engage chamber 26 of the hydraulic cylinder. The controllable check valve 23 only permits flow in one direction, but it can be controlled to change the permitted direction. For example, the controllable check valve can be controlled so that it permits flow from the forward flow line 40 to the engage chamber 26 but not from the engage chamber to the forward flow line. Alternatively, the controllable check valve can be controlled so that it permits flow from the engage chamber to the forward flow line but not from the forward flow line to the engage chamber. A transducer 42 monitors the pressure of the fluid in the engage chamber through a transducer line 422. A dump valve 43 acts as a pressure-relief valve; if for some reason the pressure rises to dangerous levels, the dump valve will relieve the pressure by venting hydraulic fluid to the reservoir 7.

A controller 44 is electrically connected to the solenoid actuator 39, the transducer 42, the electric pump motor 5, the controllable check valve 23, and the switch 200 that is closed when the pin 20 locks the swing gate member 13 in place. The controller 44 preferably includes a microprocessor. The controller is electrically connected to a display/control panel 45 that displays information for the benefit of the person operating the press and contains buttons that the operator can press to implement various functions.

Referring back to FIG. 1, the cradle assembly includes a main cradle-assembly cover 46 that is rigidly connected to the rectangular base 8. The main cradle-assembly cover also has a slide cover 47 movably connected to it. The slide cover can be moved to a completely extended position in which it completely covers the cartridge holder when viewed from the top. To ensure that the slide cover completely covers the cartridge holder 31, the slide cover is constructed so that its length is greater than the length of the cartridge holder. When the slide cover is in the completely extended position, it closes a switch 48 (schematically shown in FIG. 1) that is electrically connected to the controller 44.

The slide cover and the locking pin act as dual safety mechanisms for the injection press. The controller will not begin an injection cycle of the press unless the slide cover is in the completely extended position and the locking pin is positioned to lock the gate member. If the locking pin is removed or the sliding cover member is retracted at any point in the injection cycle prior to the ejection phase, the controller will stop the injection cycle and will vent the pressurizing fluid to the fluid reservoir. The slide cover and the locking pin are structure that perform the function of preventing the controller from actuating the pump during unsafe conditions.

Operation of the injection press will be described with reference to the molding of a partial denture using Valplast® resin. It is to be understood, however, that the use of this press to manufacture a denture using this particular resin is only one example of the uses of the invention. By modifying the parameters disclosed below, the invention disclosed and claimed in the application can be used to mold a wide range of articles of different shapes and sizes using a number of different resins.

When an operator wants to use the press to manufacture a complete or partial denture, he or she first turns on the main power switch. The operator next presses a menu button to enter the Control Mode. The operator next places a flask containing the mold into the injection cradle, closes the swing gate member 13 and secures it with the pin 20. The operator next places a bronze pressure plate 320 and the resin cartridge 32 into the resin cartridge holder 31. The bronze pressure plate protects the pressing face of the plunger from the small amount of resin that flows from the cartridge toward the back of the cradle. The operator then places the cartridge holder into a furnace (not shown) for eleven minutes to melt the resin. After this time period has expired, the operator, using the handle 34, removes the cartridge holder from the furnace and, while being careful to keep the cartridge holder horizontal, places the cartridge holder into the recess 30 in the cradle block 9. Next, the operator aligns the handle 34 with the top of the cam groove 35, and then turns the handle so that it slides within the groove. The interaction of the handle 34 with the groove 35 will cause the resin cartridge 31 holder to move forward until its front end is flush with the cylindrical recess on the back face of the flask. In this position, the cartridge is aligned with the sprue opening in the flask. Also, in this position the cartridge holder is properly aligned with the piston so that the piston rod can enter and translate within the cartridge holder. The groove restricts the axial movement of the cartridge holder during the injection process. Next the operator closes the slide cover 46. The cover activates the switch 47 when it is fully closed. With the switch activated, the display 45 reads “Gate Clsd” and “Cover Clsd,” which informs the operator that he or she can begin injection.

To start the injection, the operator presses the “F1” button on the display/control panel 45. This causes the control unit to operate the pump 6 by powering motor 5. The pump 6 then begins to draw fluid from the reservoir 7. The solenoid actuator 39 actuates the flow control valve 38 so that it sends the fluid to the forward flow line 40. The controller 44 controls the controllable check valve 23 so that it permits fluid to flow from the forward flow line 40 into the engage chamber 26 of the hydraulic cylinder but not vice-versa. The fluid in the engage chamber 26 actuates the press piston 24 to move it in the forward direction towards the resin cartridge 32. When the piston contacts the bronze pressure plate between it and the resin cartridge the resistance will cause the pressure in the fluid to rise quickly. The pressure in the engage chamber 26 is constantly monitored by the transducer 42. The pressure measured by the transducer is displayed on the display/control panel 45 in real time so that the person operating the injection press can monitor whether the injection cycle is proceeding normally. The build-up of fluid pressure in the engage chamber will increase the amount of force that the press piston 24 applies to the resin cartridge 32. At a certain pressure, the front end of the cartridge punctures and the resin inside rapidly flows to the mold cavity inside the metal flask 33. Resin then fills the mold cavity and the sprue leading from the mold cavity to the outside of the flask. The resin cartridge 32 is sized so that even when the mold cavity and the sprue opening are initially filled, a certain amount of resin will remain in the cartridge. This will allow the piston 24 to maintain back pressure on the injected resin. At the same time the piston is pressuring the cartridge and injecting fluid into the mold cavity, the pressurized fluid in the engage chamber 26 charges the accumulator 22 by pressing on the diaphragm, thereby compressing the nitrogen gas on the other side of the diaphragm.

When the resin cartridge bursts causing resin to flow under pressure into the mold cavity, the piston 24 moves forward as the cartridge 32 begins to crumple. The pressure of the fluid in the engage chamber falls slightly during this period. When the press piston 24 regains equilibrium, however, the static fluid pressure starts to rise again until it reaches the specified pressure cut-off level. When the static fluid pressure, which is measured by the transducer 42, reaches the specified pressure cut-off level, the controller will cut power to the pump motor 5 to discontinue operation of the pump 6 so that the pump no longer pressurizes the fluid in the engage chamber 26. When injecting Valplast® brand resin, it has been found that a pressure cut-off level of 1350 psi is preferable. Other pressure cut-off levels may, however, be used as the specified pressure cut-off level within the spirit and scope of the invention. In addition to cutting power to the pump motor 5, discontinuing the operation of the pump can be assisted by a brake mechanism (not shown) that rapidly brings the motor shaft and the pump components to rest. The controllable check valve 23 prevents the fluid in the engage chamber from leaving the chamber when operation of the pump is discontinued. The charged accumulator 22, however, continues to maintain pressure on the fluid in the engage chamber 26. It does so in a passive manner; the compressed nitrogen gas is the pressure source. The pressure applied to the fluid in the engage chamber by the accumulator is transmitted through the piston 24 as back pressure on the resin in the mold cavity and sprue chamber. As the resin in the mold cavity begins to cool it will also shrink. The back pressure provided by the accumulator 22 causes the additional resin in the sprue to be forced into the mold cavity to fill up voids caused by the shrinking resin in the cavity. Because the accumulator 22 provides back pressure on the resin only indirectly through the hydraulic fluid in the engage chamber 26 and the press piston 24, it does not become soiled with hardened resin. Removal of hardened resin from the accumulator would require frequent maintenance, which is undesirable. The accumulator may not able to maintain the static fluid pressure in the engage chamber at the specified cut-off level. Consequently, the pressure in the engage chamber may gradually fall before stabilizing. For example, when injecting Valplast® brand resin, the pressure in the engage chamber may fall to approximately 800-850 psi before it stabilizes.

Other auxiliary pressure devices can be used instead of an accumulator. For example, the auxiliary pressure device could be a second pump/motor combination that has a lower capacity and consumes less power.

When the controller cuts power to the motor, a timer is displayed on the display/control panel 45. When a specified time period has elapsed, the controller sounds an audible alarm, which alerts the operator that the required residence time has passed. The display/control panel will continue to display the time since motor cut-off, however. When molding with Valplast® brand resin, a residence time of three minutes is preferable. Other residence times, however, are within the spirit and scope of the invention. Upon hearing the alarm, the operator presses the “F3” button marked “Eject” on the display/control panel 45 to commence the eject cycle. The controller will then actuate the flow control valve 38 to connect the forward flow line 40 with the fluid reservoir 7 and to connect the pump 6 with the reverse flow line 41. The controller also powers the pump motor 5 so that the pump sends fluid to the retract chamber 27 of the cylinder. In addition, the controller controls the controllable check valve 23 so that it permits fluid to flow from the engage chamber 26 to the forward flow line 40 (but not vice-versa) so that the fluid in the engage chamber can be vented to the reservoir. When the piston rod 28 fully retracts, the operator removes the pin 20 from swing gate member 13 and then again pushes the “F3” button. The flow control valve 38 and the controllable check valve 23 are then again actuated to vent the retract chamber 27 and to deliver the pumped fluid to the engage chamber 26. The fluid pushes the piston 24 to move forward. Because the gate is no longer locked, when the press piston contacts the bronze pressure plate this time, it will push the bronze pressure plate, the spent cartridge and the flask off the cradle assembly. (All three of these components will be connected together by the hardened resin.) When the piston rod 28 is fully extended, the bronze pressure plate will be completely outside of the cartridge holder 31. The controller 44 then once again retracts the piston rod 28.

At this point the operator separates the flask 33, spent cartridge 32, and pressure plate. The operator may then dispose of the cartridge and clean the pressure plate so that it can be reused. The flask can be opened to remove the molded article.

For the exemplary embodiment described above, the 1350 psi cut-off value and the three-minute residence time are programmed into the controller 44. The controller, however, can be re-programmed to set a higher or lower cut-off pressure or a larger or smaller residence time depending on the particular article to be molded and the particular molding resin used.

Molding articles with acrylic resin using the described injection press that embodies the invention is accomplished by a program in the controller that implements a jog function. The controller allows the pump to deliver fluid to the engage chamber to move the piston towards the resin and allows the static pressure in the engage chamber to build up to a specified first pressure value. Preferably, this specified first pressure value is 250 psi, although other pressure values are within the scope of the invention. At the specified first pressure value, the controller cuts power to the pump motor 5 to discontinue operation of the pump 6. The accumulator, which was charged when the pump was operating, maintains pressure on the fluid but without the pump the pressure gradually falls. When the pressure reaches a specified second pressure value, the controller operates the pump once again. The second specified pressure value is preferably 200 psi, although other pressure values are within the scope of the invention. The pressure increases back to the specified first pressure value, at which point the controller cuts power to the pump motor once again. The controller repeats this sequence until the mold cavity is filled. The operator knows when the mold cavity is filled without voids when resin begins to leak out of a small diameter escape hole in the flask. When this event occurs, the operator can press a button on the display/control panel to end the injection program.

The controller 44 has stored within it a number of programs, including at least one program for molding with resins that can be rapidly injected into a mold cavity and at least one program for resins, like acrylic resin, that must be gradually advanced into the mold cavity. Each program includes a series of logic rules by which the controller generates output signals based upon input signals it receives from the transducer 42, the switches 200 and 48, and the buttons on the display/control panel 45. The output signals implement various operations in the press such as actuating a valve or cutting power to the motor 5.

Some examples of other resins besides Valplast® brand resin and methyl-methacrylate resin that can be injected with the invention are acetal resins, ethyl-acrylate polymers, silicone soft liners, other thermoplastic resins, thermosetting resins, and extrusion-grade polymers.

The invention has a number of other uses besides denture manufacturing. The invention can be used to fabricate any part that can be made with a mold that can fit into the cradle assembly of the machine and that can be filled with an amount of thermoplastic resin or suitable type of thermosetting resin having a volume that is the same or less than the resin cartridge holder. Custom-made or one-of-a-kind articles up to the size allowed by the capacity of the resin cartridge holder can be made with this machine. These include: prototypes of small articles; miniature samples of larger items that might be bigger in actual production; finished pieces that might be made by a packaging or marketing firm for use in displays; miniature articles that might be used for photography, animation, or film-making; and fabrication of full sized samples of small parts.

The invention can mass-produce small parts in the unit one at a time (typically for smaller runs) to avoid costly set-up charges that would be incurred using a commercial plastic injection company.

The invention also has laboratory and experimental uses. It can be used to test the mold shrinkage of polymers. It can be used to test a part's design to determine response of polymers when injected into a particular form. It can be used to make empirical determination of the injection and holding pressures and times for various polymers or injection moldable resins in a variety of molds and forms. The invention can be used to fabricate test pieces that might be used to test material and physical properties of injection moldable resins. Additionally, the invention can be used to test thermoset or thermoplastic resins to determine if they can be used in a small contained injection system.

In addition to these uses, the invention can be fabricated with the identical overall design but with different size and scale than the disclosed embodiments. A larger version of the press can be used to fabricate injection moldable articles whose final dimensions are larger than what is permitted by the disclosed embodiments of the invention. The invention can be scaled to allow different maximum volume limits for the resin that is injected allowing larger articles to be molded with the same machine.

A heated injection cylinder can be installed together with an external hopper that would allow the same or larger core injection system to be used in an automated injection molding process in which loose thermoplastic resin is fed into a stationary melting chamber and injected into a removable reusable mold.

Various components that are shown in the drawings are not specifically mentioned herein because they are standard mechanical and electrical components such as fasteners, hoses, nipples, couplers, switches, fuses, and relays that are routinely used in machinery. Description of these components is not required to understand the invention.

While the invention has been described with reference to specific embodiments thereof, those skilled in the art will recognize that the invention can be practiced with modifications within the spirit and scope of the claims.

What is claimed is:

1. An injection press for delivering resin into a mold cavity comprising:
a hydraulic cylinder;
a press piston located inside the hydraulic cylinder and translatable within the cylinder, the press piston dividing the hydraulic cylinder into engage and retract chambers;
a pump connected to the engage chamber, the pump delivering hydraulic fluid to the engage chamber to translate the piston in a first direction;
an accumulator connected to the engage chamber;
a controller that stops the pump from operating when the pressure in the engage chamber reaches a specified level;
wherein the accumulator continues to pressurize the fluid in the engage chamber after the controller stops the pump from operating whereby the piston applies back pressure to resin inside the mold cavity.

2. An injection press according to claim 1, further comprising:
a transducer for measuring the pressure in the engage chamber.

3. An injection press according to claim 1, further comprising:
a flow control valve connected to the pump, the flow control valve being of such construction that it can be actuated to be in a first state or a second state;
a forward flow line connected to the flow control valve and the engage chamber;
a reverse flow line connected to the flow control valve and the retract chamber;
wherein in the first state, the flow control valve delivers hydraulic fluid output from the pump to the forward flow line and the engage chamber, and in a second state, the flow control valve delivers hydraulic fluid output from the pump to the reverse flow line and the retract chamber.

4. An injection press according to claim 3, further comprising:
a fluid reservoir;
wherein when the flow control valve is in the first state, it vents hydraulic fluid in the retract chamber and the reverse flow line to the fluid reservoir, and when the flow control valve is in the second state, it vents hydraulic fluid in the engage chamber and the forward flow line to the fluid reservoir.

5. An injection press according to claim 3, further comprising:
a controllable check valve that is electrically connected to the controller, the controller maintaining the controllable check valve in one of two states;
wherein the forward flow line is connected to the engage chamber through the controllable check valve;
wherein in the first state the controllable check valve permits fluid to flow from the forward flow line to the engage chamber but not from the engage chamber to the forward flow line;
wherein in the second state the controllable check valve permits fluid to flow from the engage chamber to the forward flow line but not from the forward flow line to the engage chamber.

6. An injection press according to claim 1, further comprising:
a cradle assembly, the cradle assembly comprising the hydraulic cylinder, the piston, and the accumulator, the cradle assembly further comprising a cradle support structure;
a gate member;
a hinge connecting one end of the gate member to the cradle support structure;
at least one hole in the end of the gate member opposite to the end connected to the cradle support structure;
a hole in the cradle support structure, the at least one hole in the gate member capable of being aligned with the hole in the cradle support structure when the gate member is in a locking position;
a pin capable of locking the gate member in a fixed position by interacting with the at least one hole in the gate member and the hole in the cradle support structure.

7. An injection press according to claim 6, further comprising:
a switch that is closed by the pin when the pin interacts with the at least one hole in the gate member and the hole in the cradle support structure.

8. An injection press according to claim 1, further comprising:
a cradle assembly, the cradle assembly comprising the hydraulic cylinder, the piston, and the accumulator;
a fixed main cradle assembly cover;
a sliding cover connected to the main cradle assembly cover in a manner such that the sliding cover can extend beyond the main cradle assembly cover or retract within the main cradle assembly cover.

9. An injection press according to claim 8, further comprising:
a removable resin cartridge holder for holding the resin to be injected, the resin cartridge holder being insertable into a recess in the cradle assembly;
wherein the length of the sliding cover is greater than the length of the resin cartridge holder.

10. An injection press according to claim 8, further comprising:
a switch in electrical communication with the controller;
wherein the sliding cover closes the switch when it is fully extended with respect to the main cradle assembly cover so that the controller knows that that the sliding cover is fully extended with respect to the main cradle assembly cover.

11. An injection press according to claim 1, further comprising:
means for preventing the controller from actuating the pump during unsafe conditions.

12. An injection press according to claim 1, further comprising:
an injection cradle assembly, the injection cradle assembly comprising the hydraulic cylinder, the piston, and the accumulator, the injection cradle assembly further comprising a cradle block;
a removable resin cartridge holder for holding the resin to be injected, the resin cartridge holder being insertable into a recess in the cradle block;
a handle extending from the resin cartridge holder;
a cam groove in the cradle block;
wherein the cam groove is configured to interact with the handle so as to align the cartridge holder with the piston and restrict axial movement of the cartridge holder.

13. An injection press according to claim 1, wherein the accumulator contains nitrogen gas and is passive.

14. An injection press comprising:
a hydraulic cylinder;
a piston located inside the hydraulic cylinder and translatable within the cylinder, the press piston dividing the hydraulic cylinder into engage and retract chambers;
a pump connected to the engage chamber, the pump delivering hydraulic fluid to the engage chamber to translate the piston in a first direction;
an accumulator connected to the engage chamber;
a transducer that measures the pressure in the engage chamber;
a controller that discontinues operation of the pump when the pressure in the engage chamber reaches a specified level as measured by the transducer;
wherein the accumulator continues to pressurize the hydraulic fluid in the engage chamber after the controller discontinues operation of the pump.

15. An injection press according to claim 14, wherein:
the controller is programmable with respect to the specified level of pressure in the engage chamber.

16. An injection press according to claim 14, further comprising:
a display;
wherein the display shows the pressure in the engage chamber as measured by the transducer in real time.

17. A method for injecting resin into a mold cavity using an injection press, the injection press comprising a hydraulic cylinder, a piston located in the cylinder and dividing the cylinder into engage and retract chambers, a pump, and an accumulator connected to the engage chamber, the method comprising:
operating the pump to deliver hydraulic fluid to the engage chamber to translate the piston in a first direction and to charge the accumulator;
monitoring the pressure in the engage chamber with a transducer;
discontinuing operation of the pump when the pressure in the engage chamber as measured by the transducer rises to a specified level;
after discontinuing operation of the pump, pressurizing the fluid in the engage chamber with the accumulator for a specified period of time.

18. The method of claim 17, further comprising:
after pressurizing the fluid in the engage chamber with the accumulator for the specified period of time, operating the pump to deliver hydraulic fluid to the retract chamber to translate the piston in a second direction that is opposite to the first direction;
after operating the pump to deliver hydraulic fluid to the retract chamber, delivering hydraulic fluid to the engage chamber to extend the piston to eject the flask away from the injector.

19. The method of claim 18, wherein the injector comprises a lockable gate that prevents axial movement of the flask away from the injector during the injection process, further comprising:
after operating the pump to deliver fluid to the retract chamber but before delivering fluid from the pump to the engage chamber to extend the piston to eject the flask, unlocking the lockable gate to permit movement of the flask in a direction away from the injector.

20. A method for injecting resin into a mold cavity using an injection press, the injection press comprising a hydraulic cylinder, a piston located in the cylinder and dividing the cylinder into engage and retract chambers, a pump connected to the engage chamber for delivering hydraulic fluid to the engage chamber, and an accumulator connected to the engage chamber, the method comprising:
(1) operating the pump to pump fluid into the engage chamber to translate the piston in a first direction and to charge the accumulator;
(2) discontinuing operation of the pump when the pressure in the engage chamber rises to a first specified level so that the accumulator becomes the primary source of pressure in the engage chamber;
(3) operating the pump again when the pressure in the engage chamber falls to a second specified level;
(4) repeating steps (2) and (3) until the mold cavity is completely filled with resin.
